(19) United States
(12) Patent Application Publication
(10) Pub. No.: US 2026/0065772 A1
(43) Pub. Date: Mar. 5, 2026

(54) ALARM MANAGEMENT SYSTEMS AND METHODS

(71) Applicant: HITACHI, Ltd., Tokyo (JP)

(72) Inventors: Pegah MAVAIE, Santa Clara, CA (US); Ravigopal VENNELAKANTI, San Jose, CA (US); Malarvizhi SANKARANARAYANASAMY, Mountain View, CA (US)

(21) Appl. No.: 18/821,796

(22) Filed: Aug. 30, 2024

(51) Int. Cl. G08B 29/00; G06F 40/14; G06F 40/205

(52) U.S. Cl. CPC G08B 29/00; G06F 40/14; G06F 40/205

(57) ABSTRACT

Systems and methods for managing alarms in a process control environment involve receiving, at an LLM agent, input data from various data sources including alarm data and a parsing result from a query parser that generates the parsing result from a user query in a natural language format. To reduce the likelihood of reasoning errors, the parsing result and input data are provided to an LLM that selects an analytical function, which includes domain-specific information. The LLM uses the input data and analytical function to perform an alarm analysis, enhancing the accuracy of the analysis result. The analysis result is then used to generate an alarm summary, which reflects a severity or urgency of an alarm.

### FIELD

The present disclosure is generally directed to alarm management systems and methods, and more specifically, to alarm summarization systems and methods for managing alarms in a process control environment.

### RELATED ART

Alarm management involves the prioritization and handling of various alarms in a system to ensure that the most critical ones are addressed promptly and effectively. In scenarios where operators are overwhelmed by a large volume of alarms, critical alerts may be missed. Difficulties in prioritizing alarms can delay responses to critical situations.

In various industries, especially in process control and safety-critical environments, such as oil and gas, chemical plants, and nuclear power operations, alarm management involves handling and prioritizing a large number of system alarms. Of the various challenges in an alarm management, such as alarm overload, priority setting, data analysis and improvement, information overload is a significant challenge.

Alarm management involves alarm summarization techniques to reduce irrelevant information for different use cases. Alarm summarization is aimed at condensing alarm data into a manageable and understandable format, highlighting the most pertinent information to allow operators to make timely decisions. Simplifying complex alarm data without losing critical information to ensure that summarized information accurately reflects the severity and urgency of the situation remains a challenging task in alarm summarization. Alarm flooding and its impact on human operators are well-known in literature.

Large Language Models (LLMs), known for their ability to use natural language processing techniques to interpret and summarize data, can process alarm data to help operators focus on the most critical issues. However, despite considerable progress in the capacity of computers to handle natural language, applying LLMs to alarm summarization faces challenges such as comprehend meaning, causality issues, and hallucinations, which can limit their adaptability and accuracy. Several reasoning challenges stem from the underlying design and operation principles, while others are due to the limitations of current technology and understanding of human language and cognition.

Existing alarm management approaches can intelligently process sensor signals to create indications of anomalies. These indications can then be categorized based on the functions of the monitored system and used to generate messages about goal violations, process disturbances, and process unavailability. The messages are prioritized locally within each category and displayed, e.g., in a dedicated parallel display area, for each function. These systems aim to enhance the detection, evaluation, and response to abnormal conditions in complex environments like process control systems. However, they merely improve the operator’s ability to identify and respond to relevant alarms by organizing and presenting the data more effectively.

Therefore, what is needed are alarm management systems and summarization techniques that reduce irrelevant information and allow consolidating vast quantities of data in alarm management systems for operators to effectively triage, perform root cause analysis, take appropriate step to mitigate the causes of alarms, and properly document and report instances.

### SUMMARY

In some aspects of the disclosure, a method for managing alarms in a process control environment comprises: at an LLM agent, performing steps including: receiving input data from various data sources including alarm data: receiving a parsing result from a query parser that is configured to generate the parsing result from a user query in a natural language format; and reducing a likelihood of a reasoning error by providing the parsing result and the input data to an LLM that is configured to select an analytical function from a set of pre-defined analytical functions that each include domain-specific information; and, at an LLM, performing steps including: in response to receiving the input data and the analytical function, performing an alarm analysis to obtain an analysis result, wherein the analytical function enhances an accuracy of the analysis result; using the analysis result to generate an alarm summary that reflects at least one of a severity or an urgency associated with an alarm; and communicating the alarm summary to the LLM agent; and using a dashboard organizer to cause the alarm summary to be displayed on a user interface.

In some aspects, the alarm analysis comprises at least one of a community detection, an alarm co-occurrence analysis, a predictive analysis, or a survival analysis, which may comprise evaluating the persistence or resolution of a set of alarms over time to determine system health or to identify a time-related system issue. The alarm analysis may prioritize alarms based on a user preference.

In some aspects, the LLM agent is configured to automatically integrate a new analytical function or API into a toolset to reduce additional training or fine-tuning. The LLM agent may identify patterns or clusters within the alarm data to detect a systemic issue.

In some aspects, the user interface includes cascading style sheets (CSS) that enhance at least one of an aesthetic or a usability of a customizable dashboard, and a layout or a style of the user interface may be customizable according to a user-preference.

In some aspects, the input data includes historical alarm data that is used to forecast a future alarm occurrence. In some aspects, the system may evaluate a persistence or a resolution of alarms over time to assess the overall health of the system.

In some aspects of the disclosure, a system for managing alarms in a process control environment, the system comprises: an LLM agent configured to perform steps including: receiving input data from various data sources including alarm data; receiving a parsing result from a query parser that is configured to generate the parsing result from a user query in a natural language format; and reducing a likelihood of a reasoning error by providing the parsing result and the input data to a first large language model (LLM) that is configured to select an analytical function from a set of pre-defined analytical functions that each include domain-specific knowledge information; an LLM coupled to the LLM agent, the LLM configured to perform steps including: in response to receiving the input data and the analytical function, performing an alarm analysis to obtain an analysis result, wherein the analytical function enhances an accuracy of the analysis result; using the analysis result to generate an alarm summary that reflects at least one of a severity or an urgency associated with an alarm; and communicating the alarm summary to the LLM agent; and a dashboard organizer that is coupled to the LLM agent, the dashboard organizer configured to cause the alarm summary to be displayed on a user interface.

In some aspects, the techniques described herein relate to a system, wherein the alarm analysis includes at least one of a community detection, an alarm co-occurrence analysis, a predictive analysis, or a survival analysis. The survival analysis may include evaluating the persistence or resolution of a set of alarms over time to determine system health or to identify a time-related system issue.

Aspects of the present disclosure can involve a system, which can involve means for receiving a parsing result from a query parser that is configured to generate the parsing result from a user query in a natural language format, and for reducing a likelihood of a reasoning error by providing the parsing result and the input data to an LLM that is configured to select an analytical function from a set of pre-defined analytical functions that each include domain- specific information.

The system may further involve means for performing steps including: in response to receiving the input data and the analytical function, performing an alarm analysis to obtain an analysis result, wherein the analytical function enhances an accuracy of the analysis result; using the analysis result to generate an alarm summary that reflects at least one of a severity or an urgency associated with an alarm; and communicating the alarm summary to the LLM agent.

The system may further involve means for performing steps including causing the alarm summary to be displayed on a user interface.

### BRIEF DESCRIPTION OF DRAWINGS

FIG. 1 illustrates an exemplary system for managing alarms in a process control environment, according to various embodiments of the present disclosure.

FIG. 2 illustrates a process for managing alarms in a process control environment using general analysis, according to various embodiments of the present disclosure.

FIG. 3 illustrates a process for managing alarms in a process control environment using specialized analysis, according to various embodiments of the present disclosure.

FIG. 4 illustrates an exemplary creation of a new instance of an LLM by adding a new function, according to various embodiments of the present disclosure.

FIG. 5 illustrates a system for generating alarm summaries in a process control environment, according to various embodiments of the present disclosure.

FIG. 6 illustrates an exemplary implementation of the system shown in FIG. 5.

FIG. 7 is a flowchart illustrating an exemplary process for managing alarms in a process control environment in accordance with various embodiments of the present disclosure.

FIG. 8 illustrates an example computing environment with an example computer device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Various embodiments use an LLM to generate a customized dashboard, e.g., based on a conversation summary, configured to highlight insights that are of particular interest to the user. A user can request specific information in an alarm management system and focus on a set of aspects of the analysis. The LLM may communicate with various software applications to customize a user interaction to enhance the interactions with a dashboard, which may vary between use cases. This customization increases the user’s understanding of the displayed material (e.g., figures) and focuses on the most relevant aspects for a specific use case. Additionally, certain embodiments leverage multimodal technology to customize dashboards for users, employing Cascading Style Sheets (CSS) to enhance the dashboard’s aesthetics and elevate the overall user experience.

In embodiments, the LLM requires minimal fine-tuning and training to function effectively as a domain specialist. By providing analytical functions and prompts, the LLM can engage in dialogue and deliver proper insights. In order to mitigate the effects of a lack of powerful reasoning ability of LLMs and/or to prevent their hallucinations, embodiments herein utilize pre-defined analytical functions and an analytical LLM agent to perform a general analysis tasks reliably.

Embodiments herein may be implemented to solve a set of alarm management problems and can be expanded to include one or more of the following functions: (1) Community detection, which comprises analysis, such as similarity analysis, to identify patterns or clusters that may be present in alarm data; (2) Alarm co-occurrence analysis, which involves performing time-related analysis to identify alarms that frequently occur together, indicating potentially related issues or systemic problems; (3) Predictive analysis, which comprises utilizing historical data to predict future alarm occurrences; and (4) Survival analysis, which comprises evaluating the persistence or resolution of alarms over time to assess system health or identify long-term issues. For alarm analysis and summarization, a system that analyzes alarms and provides a summarized dashboard based on user queries, e.g., an inquiry into the number of daily alarms registered.

Advantageously, natural language interaction with alarm data enables users to interact with the alarm system using natural language queries to enhance usability and accessibility. Customizable summary dashboards may provide users with tailored dashboards that summarize their specific queries and interactions with the system.

Thus, embodiments herein integrate advanced data analysis techniques with user-friendly interfaces, aiming to enhance the efficiency and effectiveness of alarm management systems.

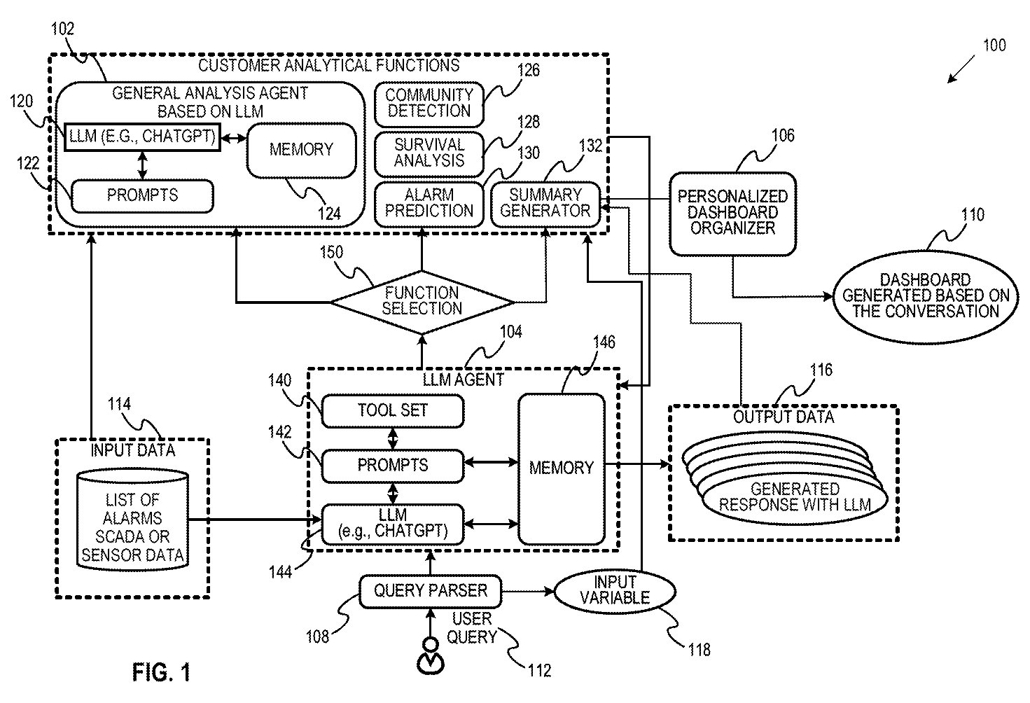

FIG. 1 illustrates an exemplary system for managing alarms in a process control environment, according to various embodiments of the present disclosure. In embodiments, system 100 comprises general analysis agent 102, LLM agent 104, personalized dashboard organizer 106, and query parser 108. As depicted, general analysis agent 102 may comprise LLM 120 that receives prompts 122 and is coupled to memory 124.

LLM agent 104 may comprise toolset 140, LLM 144, and memory 146 that stores conversations a user may have when interacting with LLM 144. Prompts 142 may comprise instructions on how to use toolset 140 and how to parse user query 112.

In embodiments, general analysis agent 102 may perform a general analysis using LLM 120 to answer a general user question, such as: “What is the number of average daily alarms?” It is noted that these embodiments do not require components such as community detection 126, survival analysis 128, alarm prediction 130, and summary generator 132, and personalized dashboard organizer 106, which are used for more complex queries.

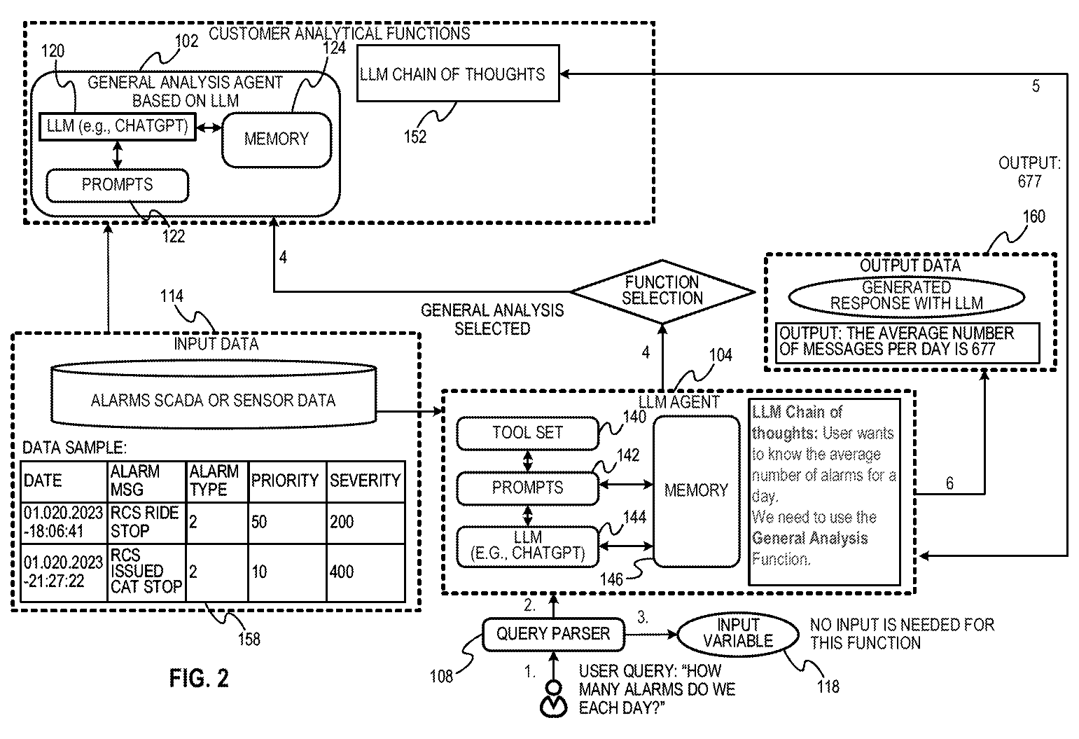

In operation, in response to a user submitting a question, e.g., in the form of user query 112, LLM 144 may use input data 114 to answer the question. In embodiments, input data 114 may be obtained from an external data source, may comprise a tabular data, such as a list of dates, alarm messages, message types, and priority and severity information (not shown in FIG. 1). In embodiments, LLM 144 uses query parser 108 to parse question 112 to extract information, such as the type of analysis required, specific alarm, and other context information or previous interactions. LLM 144 may then map that information to toolset 140 to decide, e.g., based on semantic similarity, whether a general analysis function or any other predefined analytical function should be selected and/or used. For a general analysis function, which may also serve as the default function if the query result lacks certain parameters or parameters cannot identified, LLM 144 may use prompt 142 to call LLM 120 in general analysis agent 102 to select the general analysis function to provide the answer. As depicted in FIG. 2, which illustrates a process for managing alarms in a process control environment using general analysis, according to various embodiments of the present disclosure, a corresponding “chain of thoughts” for LLM 144 may be “The user wants to know the average number of alarms for a day. We need to use the General Analysis Function.”

In embodiments, illustrated in FIG. 2, the general analysis function does not require additional inputs, arguments, or parameters. In other words, general analysis agent 102 may be viewed as one of the components in toolset 140 that provides an answer to the user’s question and communicates it to LLM agent 104. As depicted, LLM 120 in general analysis agent 102 may have a corresponding chain of thoughts 152, e.g., “the user wants to know the average number of alarms for a day. I need to calculate the average number of 'clean_message' we receive each day. To calculate the average number of messages per day, we first need to convert the 'timestamp' column to datetime format, then extract the date, and finally group by the date and count the number of messages. Here is how you can do it: … Python Code provided by LLMs … Let’s run this code: 677.0. The average number of messages per day in the dataframe is 677.” Once LLM agent 104 receives the final answer, here 677, it may output it in any format as output data 116.

It is noted that the general analysis function may be a part of toolset 140. In addition to general analysis component 102, various amount of supporting functions may be defined to perform more complex operations and data analysis.

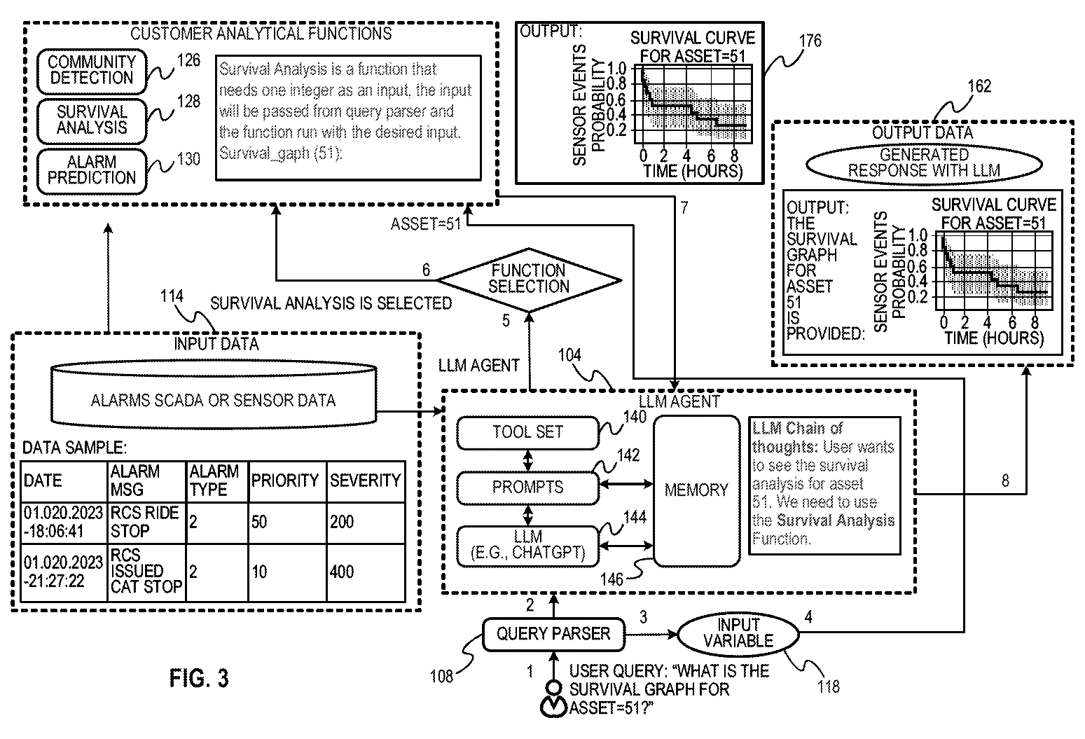

FIG. 3 illustrates a process for managing alarms in a process control environment using specialized analysis, according to various embodiments of the present disclosure. Similar components as those shown in FIG. 1 and FIG. 2 are labelled in the same manner.

In operation, a user asks a question and, as before, LLM 144 may use query parser 108 to pars the question and obtain a query result. If LLM 144 decides that the question can be answered by using an existing function based on the provided prompt and template input, LLM 144 may match the query result a suitable function, select the function from a list of function, extract input arguments from the query result for the selected function, and use input variable 118 to call the selected function.

As depicted in the example in FIG. 3, in response to user question 112 “What is the survival graph for asset= 51?,” LLM 144 creates a chain of thoughts “The user wants to see the survival analysis for asset 51. We need to use the Survival Analysis Function.” After determining that the question can be answered by using a survival analysis, LLM 144 selects a survival function, which may be implemented as an algorithm, to obtain the answer to the user’s question. LLM agent 104 communicates the selection, along with input variable 118 to, an LLM (not shown in FIG. 3) to obtain output 176, here a survival graph for asset 51, which LLM agent 104 presents as the final answer 162.

Utilizing a general analysis agent (shown in FIG. 2) and predefined functions in this manner enables LLMs to obtain domain knowledge and improves the reasoning ability of the LLMs for complex operation, which, advantageously, reduces possible hallucinations and allows users to gain insight based on the pre-defined functions.

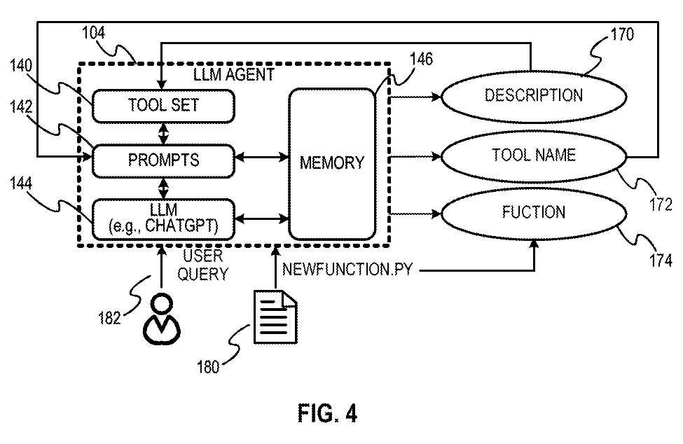

FIG. 4 illustrates an exemplary creation of a new instance of an LLM by adding a new function, according to various embodiments of the present disclosure. In embodiments, to add new functionalities to an LLM, code may be integrated into toolset 140. A detailed description 170 of the to-be-added function may be used for prompt engineering. In embodiments, LLM 144 may be used to generate such detailed descriptions by using user query 182 to facilitate the integration of any type of function 174 or API into the LLM framework.

An exemplary process for adding new function 174 comprises LLM agent 104 obtaining input data 180 (e.g., Python code) and user query 182 (e.g., “Add this function to the Analytical Functions”). LLM agent 104 may use LLM 144 to generate and communicate a prompt to user (e.g., “What is this code doing”) to solicit description 170 as a user response. Another prompt (e.g., “What is the name of the function”) may solicit tool name 172 for a specific toolset as a response. Finally, the newly generated function may be added into the toolset, creating a new instance of LLM 144 having the added functionality of the new function. Advantageously, automatically integrating functions with LLMs into the toolset can broaden the framework’s applicability across various domains with minimal need for additional training or fine-tuning of the LLMs.

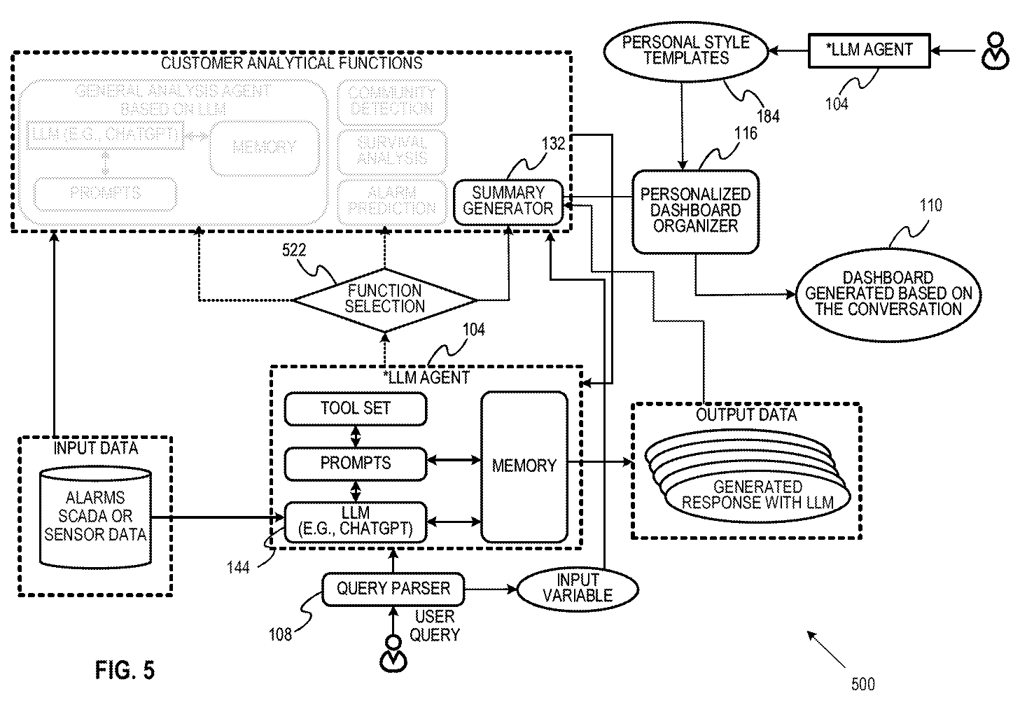

FIG. 5 illustrates an exemplary system for generating alarm summaries in a process control environment, according to various embodiments of the present disclosure. System 500 comprises summary generator 132 that generates dashboard 110, personal dashboard organizer 106, and personal style template 184. In embodiments, a user may request a summary of previously provided responses that the LLM agent 104 generated. Summary generator 132 may provide a summary in customized version of dashboard 110, e.g., based on user preferences. The users may request summaries in the form of natural language queries 112, and LLM 144 may use query parser 108 to parse the question to choose the summary generation function from a list of possible functions. In embodiments, to cause personal dashboard organizer 106 to generate customized dashboard 110 that is personalized according to personal style template 184, the summary generation function may create a Python-based dashboard and display the result to the user on dashboard 110. It is understood that dashboard 110, which may be based on or comprise at least some of the chat history, may be automatically created.

In embodiments, personal dashboard organizer 106 may arrange dashboard 110 in a manner such as to enhance the information gain (IG), ideally without deviating from the chosen personal style. This arrangement may be achieved by defining an IG factor for each displayed component. The components on dashboard 110 can then be arranged such as to maximize a score associated with all IG factors.

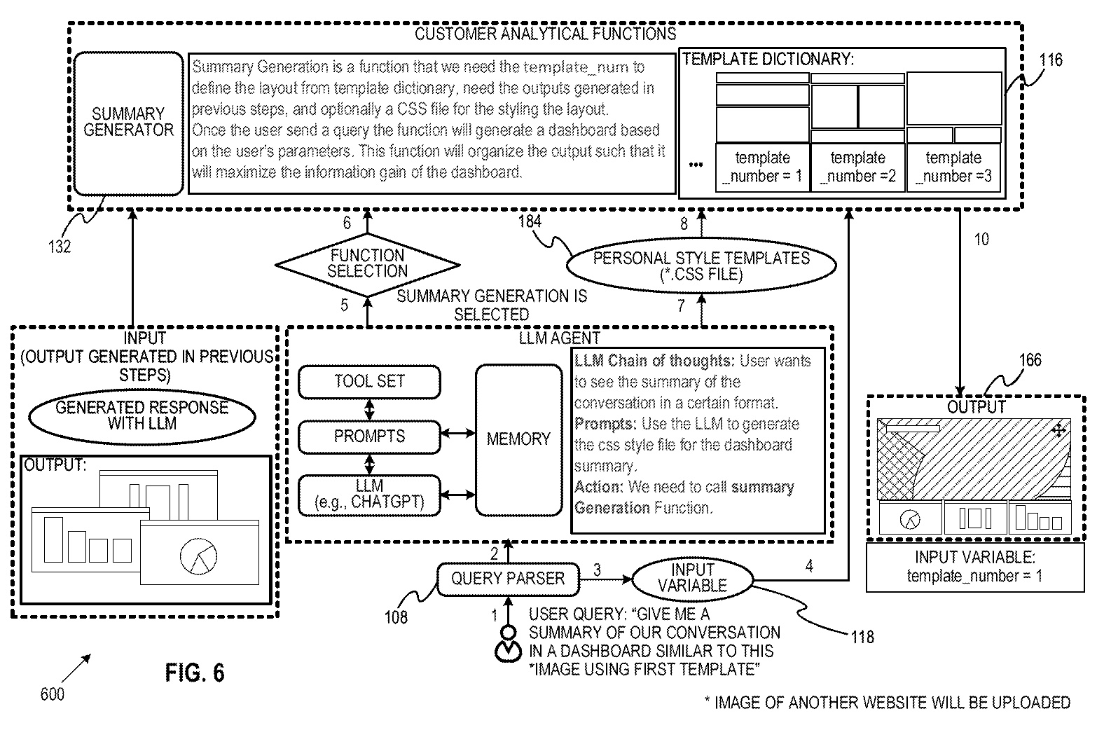

FIG. 6 illustrates an exemplary implementation of the system shown in FIG. 5, according to various embodiments of the present disclosure. In embodiments, LLM 144 receives natural language query 112 from a user, such as “Give me a summary of our conversation in a dashboard similar to this *image using first template,” along with a user-provided image whose features may serve as a guide for a layout of output 166.

Based on the relevant information extracted from query 112 and the provided image, LLM 144 may then create a prompt comprising a chain of thoughts, such as “The user wants to see the summary of the conversation in a certain format. Prompts: Use the LLM to generate the css style file for the dashboard summary. Action: We need to call summary Generation Function,” as depicted in FIG. 6.

In embodiments, using this prompt as an input, the LLM that specializes in executing analytical functions with domain-specific knowledge may then select and apply the selected summary generation function from the predefined analytical functions to enhance the accuracy of the analysis results. The specialized LLM’s own prompt may comprise a corresponding chain of thoughts, such as “Summary Generation is a function that we need the template_num to define the layout from template dictionary, need the outputs generated in previous steps, and optionally a CSS file for the styling the layout. Once the user sends a query the function will generate a dashboard based on the user’s parameters. This function will organize the output such that it will maximize the information gain of the dashboard.”

System 600 then executes the summary generation function, utilizing the predefined template and personal style template 184 to generate customized output 166, which reflects the user’s query and the features from the user-provided image. Output 166 is designed to maximize information gain, presenting the summarized result in a format according to the user’s preferences. This customization enhances the user’s understanding and decision-making capabilities. The final output may be displayed on the user interface.

Overall, users can interact with the system in a conversational manner, making it user-friendly and accessible to a broad audience, regardless of technical expertise. The system generates personalized dashboards that display relevant information and summaries using advanced LLM technology. This approach ensures that the information presented is tailored to the specific needs and context of each user.

By leveraging user-specific data summarization, the system curates results and generates models based on user queries. This enables the differentiation between critical alerts requiring immediate attention and less urgent notifications, helping users manage their time and attention more efficiently. As the complexity of managing extensive structured data in applications like alarm management grows, the system provides a new data representation method that computers can fully process and understand, surpassing the capabilities of current AI and machine learning technologies.

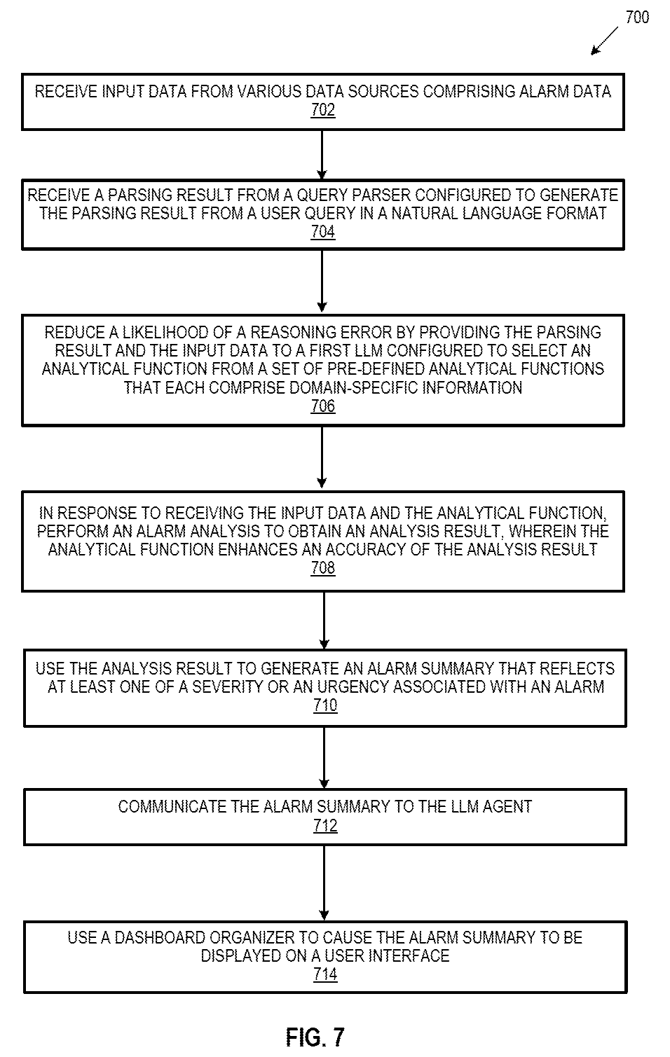

FIG. 7 is a flowchart illustrating an exemplary process for managing alarms in a process control environment in accordance with various embodiments of the present disclosure. In embodiments, process 700 begins at step 702, when input data is received from various data sources, which may comprise alarm data.

At step 704, a parsing result is received from a query parser. The query parser is configured to generate the parsing result from a user query in a natural language format.

At step 706, a likelihood of a reasoning error is reduced by providing the parsing result and the input data to a first LLM that is configured to select an analytical function from a set of pre-defined analytical functions that each comprises domain-specific information.

At step 708, in response to receiving the input data and the analytical function, an alarm analysis is performed to obtain an analysis result. The analytical function enhances the accuracy of the analysis result.

At step 710, the analysis result is used to generate an alarm summary that reflects at least one of a severity or urgency associated with an alarm.

At step 712, the alarm summary is communicated to the LLM agent.

Finally, at step 714, a dashboard organizer is used to cause the alarm summary to be displayed on a user interface.

It is noted that although the invention is generally described in the context of alarm management systems that interact with an LLM agent to address some of the challenges in alarm management system, it is understood that this is not intended to limit the scope of the present disclosure to such embodiments as the analytical functions described herein may be used in various other industrial domains.

One skilled in the art shall recognize that: (1) certain steps may optionally be performed; (2) steps may not be limited to the specific order set forth herein; (3) certain steps may be performed in different orders; and (4) certain steps may be done concurrently.

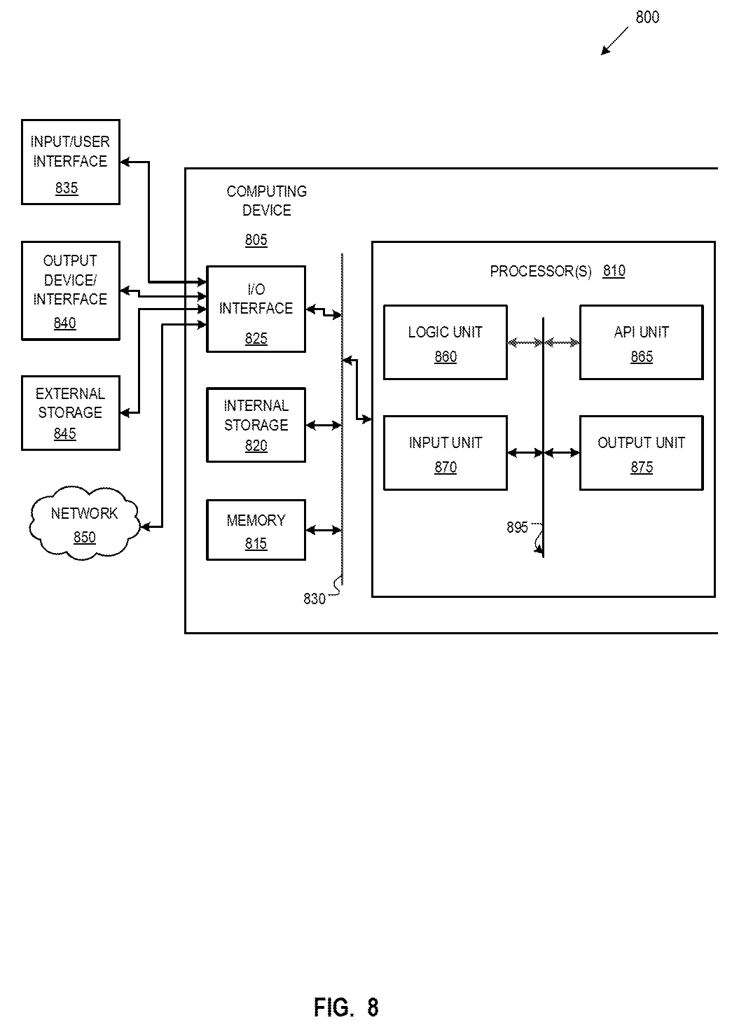

FIG. 8 illustrates an example computing environment with an example computer device suitable for use in some example implementations. Computer device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or I/O interface 825, any of which can be coupled on a communication mechanism or bus 830 for communicating information or embedded in the computer device 805. I/O interface 825 is also configured to receive images from cameras or provide images to projectors or displays, depending on the desired implementation.

Computer device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configurations. Computer device 805 or any connected computer device can be functioning as, providing services of, or referred to as a server, client, thin server, general machine, special-purpose machine, or another label.

I/O interface 825 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, a satellite network, and the like).

Computer device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, input unit 870, and output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide output based on the calculations described in example implementations.

Processor(s) 810 can be configured to execute a method or computer instructions which can involve, receiving a parsing result from a query parser that is configured to generate the parsing result from a user query in a natural language format, and for reducing a likelihood of a reasoning error by providing the parsing result and the input data to an LLM that is configured to select an analytical function from a set of pre-defined analytical functions that each include domain-specific information, as described, for example, with respect to FIG. 3 and FIG. 5

Processor(s) 810 can further be configured to execute a method or computer instructions which can involve, in response to receiving the input data and the analytical function, performing an alarm analysis to obtain an analysis result, wherein the analytical function enhances an accuracy of the analysis result; using the analysis result to generate an alarm summary that reflects at least one of a severity or an urgency associated with an alarm; and communicating the alarm summary to the LLM agent, as described, for example, with respect to FIG. 1 and FIG. 7. Processor(s) 810 can also be configured to execute a method or computer instructions which can involve causing the alarm summary to be displayed on a user interface, as described, for example, with respect to FIG. 5 and FIG. 6.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A system for managing alarms in a process control environment, the system comprising:
a large language model (LLM) agent configured to perform steps comprising:
receiving input data from various data sources comprising alarm data;
receiving a parsing result from a query parser that is configured to generate the parsing result from a user query in a natural language format; and
reducing a likelihood of a reasoning error by providing the parsing result and the input data to a first large language model (LLM) that is configured to select an analytical function from a set of pre-defined analytical functions that each comprises domain-specific information;
an LLM coupled to the LLM agent, the LLM configured to perform steps comprising:
in response to receiving the input data and the analytical function, performing an alarm analysis to obtain an analysis result, wherein the analytical function enhances an accuracy of the analysis result;
using the analysis result to generate an alarm summary that reflects at least one of a severity or an urgency associated with an alarm; and
communicating the alarm summary to the LLM agent; and
a dashboard organizer that is coupled to the LLM agent, the dashboard organizer configured to cause the alarm summary to be displayed on a user interface.

2. The system of claim 1, wherein the alarm analysis comprises at least one of a community detection, an alarm co-occurrence analysis, a predictive analysis, or a survival analysis.

3. The system of claim 2, wherein the alarm co-occurrence analysis comprises performing a time-related analysis and identifying alarms that frequently occur together to identify related issues or systemic problems.

4. The system of claim 2, wherein the survival analysis comprises evaluating a persistence or resolution of a set of alarms over time to determine system health or to identify a time-related system issue.

5. The system of claim 1, wherein the LLM agent is configured to automatically integrate a new analytical function or API into a toolset to reduce additional training or fine-tuning.

6. The system of claim 1, wherein the user interface comprises cascading style sheets (CSS) that enhance at least one of an aesthetic or a usability of a customizable dashboard.

7. The system of claim 1, wherein at least one of a layout or a style of the user interface is customizable according to user-preference.

8. The system of claim 1, wherein the LLM agent is further configured to identify a pattern or a cluster within the alarm data to detect a systemic issue.

9. The system of claim 1, wherein the input data comprises historical alarm data that is used to forecast a future alarm occurrence.

10. The system of claim 1, wherein the alarm analysis comprises prioritizing alarms based on a user preference.

11. A method for managing alarms in a process control environment, the method comprising:
at a large language model (LLM) agent, performing steps comprising:
receiving input data from various data sources comprising alarm data:
receiving a parsing result from a query parser that is configured to generate the parsing result from a user query in a natural language format; and
reducing a likelihood of a reasoning error by providing the parsing result and the input data to an LLM configured to select an analytical function from a set of pre-defined analytical functions that each comprises domain-specific information; and
at an LLM, performing steps comprising:
in response to receiving the input data and the analytical function, performing an alarm analysis to obtain an analysis result, wherein the analytical function enhances an accuracy of the analysis result;
using the analysis result to generate an alarm summary that reflects at least one of a severity or an urgency associated with an alarm; and
communicating the alarm summary to the LLM agent; and
using a dashboard organizer to cause the alarm summary to be displayed on a user interface.

12. The method of claim 11, wherein the alarm analysis comprises at least one of a community detection, an alarm co-occurrence analysis, a predictive analysis, or a survival analysis.

13. The method of claim 12, wherein the survival analysis comprises evaluating a persistence or resolution of a set of alarms over time to determine system health or to identify a time-related system issue.

14. The method of claim 11, wherein the LLM agent is configured to automatically integrate a new analytical function or API into a toolset to reduce additional training or fine-tuning.

15. The method of claim 11, wherein the user interface comprises cascading style sheets (CSS) that enhance at least one of an aesthetic or a usability of a customizable dashboard.

16. The method of claim 11, wherein at least one of a layout or a style of the user interface is customizable according to user-preference.

17. The method of claim 11, wherein the LLM agent is further configured to identify patterns or clusters within the alarm data to detect a systemic issue.

18. The method of claim 11, wherein the input data comprises historical alarm data that is used to forecast a future alarm occurrence.

19. The method of claim 11, wherein the alarm analysis comprises prioritizing alarms based on a user preference.

20. The method of claim 11, wherein the method evaluates a persistence or a resolution of alarms over time to assess an overall health of a system.
